(19) United States
(12) Patent Application Publication
(10) Pub. No.: US 2016/0092727 A1
(43) Pub. Date: Mar. 31, 2016

(54) TRACKING HUMANS IN VIDEO IMAGES

(71) Applicant: ALCATEL-LUCENT USA INC., Murray Hill, NJ (US)

(72) Inventors: Yansong Ren, Plano, TX (US); Thomas Woo, Murray Hill, NJ (US)

(21) Appl. No.: 14/502,806

(22) Filed: Sep. 30, 2014

(51) Int. Cl. G06K 9/00; G06T 7/20; G06T 7/00

(52) U.S. Cl. CPC G06K 9/00369; G06T 7/0081; G06T 7/0093; G06T 7/0097; G06T 7/0044; G06T 7/2006; G06T 7/2066; G06K 9/00778; G06K 9/00711; G06T 2207/10016; G06T 2207/20072; G06T 2207/20021; G06T 2207/20144; G06T 2207/30196; G06T 2207/30232

(57) ABSTRACT

A processor accesses a first video image and a second video image from a sequence of video images and applies a patch descriptor technique to determine a first portion of the first video image that encompasses a first person. The processor determines a location of the first person in the second video image by comparing keypoints in the first portion of the first video image to one or more keypoints in the second video image.

### BACKGROUND

1. Field of the Disclosure

The present disclosure relates generally to identifying humans in images and, more particularly, tracking humans in video images.

2. Description of the Related Art

Crowd management is becoming an urgent global concern. A good understanding of the number of people in a public space and their movement through the public space can provide a baseline for automatic security and protection, as well as facilitating monitoring and design of public spaces for safety, efficiency, and comfort. Video-based imagery systems may be used in combination with the data generated by surveillance systems to detect, count, or track people. However, reliably detecting and tracking people in a crowd scene remains a difficult problem. For example, occlusions of people (by other people or objects) make it difficult to detect the occluded person and to track the person as they pass in and out of the occlusion. Detection of individuals may also be complicated by factors such as the variable appearance of people due to different body poses or different sizes of individuals, variations in the background due to lighting changes or camera angles, or different accessories such as bags or umbrellas carried by people.

Conventional human detection techniques such as the Histogram of Oriented Gradients (HOG) are designed to detect people in static images based on a distribution of intensity gradients or edge directions in a static image. For example, a static image can be divided into cells and the cells are subdivided into pixels. Each cell is characterized by a histogram of intensity gradients at each of the pixels in the cell, which may be referred to as a HOG descriptor for the cell. The HOG descriptors may be referred to as “patch descriptors” because they represent a property of the image at each pixel within a cell corresponding to a “patch” of the image. The HOG descriptors for the cells associated with a static image may then be compared to libraries of models to detect humans in the static image. One significant drawback to patch descriptor techniques such as HOG is that they often fail to detect occluded people (i.e., people who are partially or fully obscured by objects or other people) or people wearing colors that do not contrast sufficiently with the background.

The HOG technique may be combined with a Histogram Of Flow (HOF) technique to track people using optical flow (i.e., the pattern of apparent motion of objects, services, or edges caused by relative motion between the camera and the scene) in a sequence of video images. The HOF technique characterizes each cell in each video image by a histogram of gradients in the optical flow measured at each of the pixels in the cell. Thus, the HOF is also a patch descriptor technique. Relative to the HOG technique alone, combining the HOG technique and the HOF technique may improve the counting accuracy for a sequence of video images. However, detecting and tracking moving people using patch descriptors requires generating patch descriptors for all of the cells in each video image and consequently requires a high level of computational complexity that does not allow people to be detected or tracked in real-time. Furthermore, HOG, HOF, and other conventional techniques only yield reliable measurements when minimal occlusions occur, e.g., at relatively low densities of people.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a diagram of a sequence of video images according to some embodiments.

FIG. 2 is a diagram of a background image computed for the video images according to some embodiments.

FIG. 3 is a diagram of a sequence of foreground images according to some embodiments.

FIG. 4 is a diagram that illustrates using keypoints to identify a human in bounding boxes from different video images according to some embodiments.

FIG. 5 is a diagram that illustrates using keypoints to identify a human in a bounding box of one video image and a candidate region of another video image according to some embodiments.

FIG. 6 is a diagram of a video frame including a candidate region around a human according to some embodiments.

FIG. 7 is a flow diagram of a method for identifying and tracking humans in a sequence of video images according to some embodiments.

FIG. 8 is a flow diagram of a method for comparing keypoints in bounding boxes in different video images according to some embodiments.

FIG. 9 is a flow diagram of a method for comparing keypoints in a bounding box in a first video image to keypoints in a candidate region of a second video image according to some embodiments.

FIG. 10 is a block diagram of a video processing system according to some embodiments.

### DETAILED DESCRIPTION

Humans can be detected or tracked in sequences of video images by identifying keypoints in portions of the video images that correspond to humans identified by applying a patch descriptor technique, such as the HOG technique, to the video images. A pixel is determined to be a keypoint if at least a threshold percentage of pixels within a radius of the pixel are brighter or darker than the pixel. The portions of the video images may be represented as bounding boxes that encompass a portion of the video image. Sets of keypoints identified within the bounding boxes in pairs of video images are compared to each other and associated with the same human if a matching criterion is satisfied. The characteristics of the keypoints may be represented by descriptors such as a binary descriptor or a vector of integers. For example, two keypoints may match if a statistical measure of the differences between binary descriptors for the two keypoints, such as a Hamming distance, is less than a threshold value. For another example, two keypoints may match if a statistical measure of the difference between vectors of integers that represent the two keypoints is less than a threshold value. Bounding boxes in the pairs of video images are determined to represent the same human if a percentage of matching keypoints in the two bounding boxes exceeds a threshold percentage. In some embodiments, keypoints in different bounding boxes may be filtered based on a motion vector determined based on the locations of the bounding boxes in the video images. Keypoints associated with motion vectors that exceed a threshold magnitude may not be compared. A motion history, including directions and speeds, can then be calculated for each human identified in the video images. The motion history may be used to predict future locations of the humans identified in the video images.

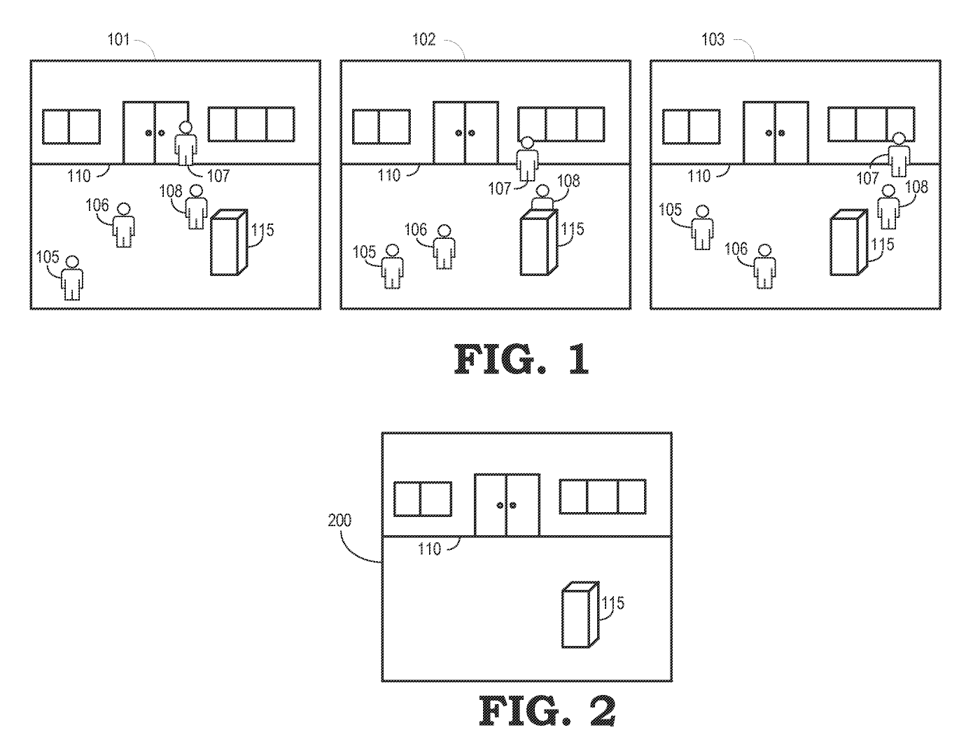

FIG. 1 is a diagram of a sequence of video images 101, 102, 103 according to some embodiments. The video images 101, 102, 103 may be referred to collectively as “the video images 101-103” and may be a subset of a larger sequence of video images such as frames captured by a video camera or surveillance camera trained on a scene including one or more people. The video images 101-103 include images of humans 105, 106, 107, 108, which may be referred to collectively as the humans 105-108. The positions of the humans 105-108 in the video images 101-103 changes due to motion of the humans 105-108. The video images 101-103 also include a building 110 and one or more objects 115. The building 110 and the object 115 remain stationary in the video images 101-103 and may therefore be considered a part of the background of the video images 101-103. Although embodiments described herein described identifying and tracking “humans,” some embodiments may be used to track other moving animals or non-stationary objects that may appear in the video images 101-103.

FIG. 2 is a diagram of a background image 200 computed for the video images 101-103 according to some embodiments. Non-stationary features of the video images 101-103 shown in FIG. 1 have been removed from the background image 200 so that the background image 200 includes stationary features such as the building 110 and the object 115. In some embodiments, the background image 200 may be generated by comparing pixel values for a predetermined set of video images. For example, the first 50 frames of a sequence that includes the video images 101-103 may be used to generate average values at each pixel location. Averaging the pixel values may substantially remove variations in the pixel values caused by non-stationary features such as the humans 105-108. The average values may therefore represent the background image 200. In some embodiments, the predetermined set of video images may be selected based on a number of humans in the images so that the background image 200 is calculated using images that include a relatively small number of humans. Background images such as the background image 200 may also be periodically re-calculated for the same scene, e.g., to account for variable lighting conditions or camera perspectives.

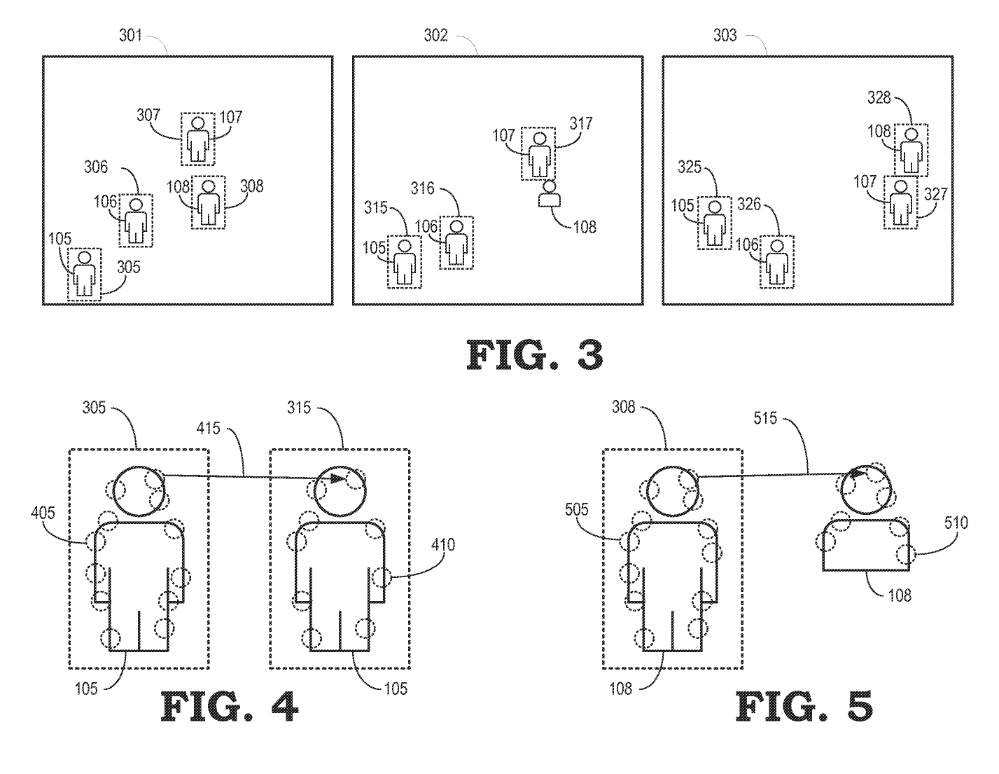

FIG. 3 is a diagram of a sequence of foreground images 301, 302, 303 according to some embodiments. The foreground images 301, 302, 303 may be referred to collectively as “the foreground images 301-303.” In some embodiments, the foreground images 301-303 are produced by subtracting the background image 200 shown in FIG. 2 from the corresponding video images 101-103 shown in FIG. 1. Subtracting the stationary features in the background image 200 from the video images 101-103 may result in the foreground images 301-303 including non-stationary features such as the humans 105-108. The human 108 is partially occluded by the stationary object 115 in FIG. 1 and consequently only a non-occluded portion of the human 108 is present in the foreground image 302.

A patch descriptor technique may be applied to the foreground images 301-303 to identify portions of the foreground images 301-303 that include the humans 105-108. Some embodiments may apply a patch descriptor technique such as a histogram-of-gradients (HOG) technique to define bounding boxes 305, 306, 307, 308 (collectively referred to as “the bounding boxes 305-308”) that define the portions of the foreground image 301 that include the corresponding humans 105-108. For example, the bounding boxes 305-308 may be defined by dividing the foreground image 301 into small connected regions, called cells, and compiling a histogram of gradient directions or edge orientations for the pixels within each cell. The combination of these histograms represents a HOG descriptor, which can be compared to public or proprietary libraries of models of HOG descriptors for humans to identify the bounding boxes 305-308.

Patch descriptor techniques such as the HOG technique may effectively identify the bounding boxes 305-308 for the humans 105-108 in the static foreground image 301. However, patch descriptor techniques may fail to detect humans when occlusion occurs or when the color of people's clothes is similar to the background. For example, the patch descriptor technique may identify the bounding boxes 315, 316, 317 for the fully visible humans 105-107 but may fail to identify a bounding box for the occluded human 108 in the foreground image 302. The human 108 is no longer occluded in the foreground image 303 and so the patch descriptor technique identifies the bounding boxes 325, 326, 327, 328 for the humans 105-108 in the foreground image 303. Although the patch descriptor techniques may identify the bounding boxes 305-308, 315-317, and 325-328 in the foreground images 301-303, the patch descriptor techniques only operate on the static foreground images 301-303 separately and do not associate the bounding boxes with humans across the foreground images 301-303. For example, the patch descriptor techniques do not recognize that the same human 105 is in the bounding boxes 305, 315, 325.

FIG. 4 is a diagram that illustrates using keypoints to identify a human 105 in bounding boxes 305, 315 from different video images according to some embodiments. Keypoints 405 (only one indicated by a reference numeral in the interest of clarity) may be identified using the image of the human 105 within the bounding box 305. In some embodiments, the keypoints 405 are identified by evaluating pixel points within the bounding box 305 and identifying pixels as keypoints 405 if a predetermined percentage of pixels on a circle of fixed radius around a given pixel point are significantly brighter or darker than the pixel under evaluation. For example, threshold values may be set for the percentage of pixels that indicates a keypoint and the brightness differential that indicates that the pixel point is significantly brighter or darker than the pixel under evaluation. The brightness differential between pixels can then be compared to the brightness differential threshold and keypoints 405 may be identified in response to the percentage of pixels that exceed the brightness differential threshold exceeding the percentage threshold. Keypoints 410 (only one indicated by a reference numeral in the interest of clarity) may also be identified using the image of the human 105 within the bounding box 315.

Some embodiments of the keypoints 405, 410 may be represented as binary descriptors that describe an intensity pattern in a predetermined area surrounding the keypoints 405, 410. For example, the keypoint 405 may be described using a binary descriptor that includes a string of 512 bits that indicate the relative intensity values for 512 pairs of points in a sampling pattern that samples locations within the predetermined area around the keypoint 405. A bit in the binary descriptor is set to “1” if the intensity value at the first point in the pair is larger than the second point and is set to “0” if the intensity value at the first point is smaller than the second point. In other embodiments, the keypoints 405, 410 may be represented as a vector of integers that describe an intensity pattern in a predetermined area surrounding the keypoints 405, 410.

The appearance of the human 105 may not change significantly between the images 301, 302 that include the bounding boxes 305, 315. Consequently, the human 105 may be identified and tracked from its location in the image 301 to its location in the image 302 by comparing the keypoints 405 in the bounding box 305 to the keypoints 410 in the bounding box 315. In some embodiments, the binary descriptors of the keypoints 405, 410 can be compared by determining a measure of the difference between the binary descriptors. For example, a Hamming distance between the binary descriptors may be computed by summing the exclusive-OR values of corresponding pairs of bits in the binary descriptors. A smaller Hamming distance indicates a smaller difference between the binary descriptors and a higher likelihood of a match between the corresponding keypoints 405, 410. The keypoints 405, 410 may therefore be matched or associated with each other if the value of the Hamming distance is less than a threshold. For example, a pair of matching keypoints 405, 410 is indicated by the arrow 415. In some embodiments, a vector of integers representative of the keypoints 405, 410 may be compared to determine whether the keypoints 405, 410 match each other. In some embodiments, a measure of color similarity between the keypoints 405, 410 may be used to determine whether the keypoints 405, 410 match. For example, keypoints 405, 410 may not match if the keypoint 405 is predominantly red and the keypoint 410 is predominantly blue. Binary descriptors, vectors of integers, colors, or other characteristics of the keypoints 405, 410 may also be used in combination with each other to determine whether the keypoints 405, 410 match.

The human 105 may be identified in the bounding boxes 305, 315 if a percentage of the matching keypoints 405, 410 exceeds a threshold. For example, twelve keypoints 405 are identified in the bounding box 305 and these are determined to match the nine keypoints 410 identified in the bounding box 315. Thus, 75% of the keypoints 405 are determined to match keypoints 410 in the bounding box 315, which may exceed a threshold such as a 50% match rate for the keypoints. Conversely, all of the nine keypoints 410 identified in the bounding box 315 matched keypoints 405 identified in the bounding box 305, which is a 100% match rate. Match rates may be defined in either “direction,” e.g. from the bounding box 305 to the bounding box 315 or from the bounding box 315 to the bounding box 305. In some embodiments, a motion history may be generated for the human 105 in response to determining that the human 105 is identified in the bounding boxes 305, 315. The motion history may include the identified locations of the human 105, a direction of motion of the human 105, a speed of the human 105, and the like. The motion history may be determined using averages over a predetermined number of previous video images or other combinations of information generated from one or more previous video images.

Furthermore, although FIG. 4 illustrates the comparison between keypoints 405, 410 in the bounding boxes 305, 315, some embodiments may compare the keypoints 405 in the bounding box 305 to keypoints in multiple bounding boxes, such as the bounding boxes 316, 317 in the image 302 or the bounding boxes 325-328 in the image 303 shown in FIG. 3. The bounding box associated with the human 105 may then be selected as the bounding box that has the highest match rate that is also above the threshold match rate. In some embodiments, the bounding boxes that are compared may be filtered based on a velocity threshold so that pairs of bounding boxes that are separated by a distance that implies a velocity in excess of the velocity threshold are not compared. The keypoints 405 in the bounding box 305 may also be compared to keypoints identified in regions that are not within a bounding box, e.g., to detect occluded people.

FIG. 5 is a diagram that illustrates using keypoints to identify a human 108 in a bounding box 308 of one video image 301 and a candidate region of another video image according to some embodiments. Keypoints 505 (only one indicated by a reference numeral in the interest of clarity) may be identified using the image of the human 108 within the bounding box 308, as discussed herein.

The location of the human 108 (or the bounding box 308) in the video image 301 may be used to define a candidate region to search for an image of the occluded human 108 in the video image 302. For example, the candidate region may be defined by extending the bounding box 308 by a ratio such as 1.2 times the length and height of the bounding box 308. For another example, the candidate region may be defined as a circular region about the location of the human 108 in the video image 301. The circular region may have a radius that corresponds to a speed of the human 108 indicated in the corresponding motion history or to a maximum speed of the human 108. For yet another example, the candidate region may be defined as a region (such as a circle or rectangle) that is displaced from the location of the human 108 in the video image 302 by a distance that is determined based on a speed and direction of the human 108 indicated in the corresponding motion history. If the human 108 is present in the candidate region, as illustrated in FIG. 5, keypoints 510 (only one indicated by a reference numeral in the interest of clarity) may be identified in the candidate region, as discussed herein.

The keypoints 505, 510 may be compared on the basis of a Hamming distance between their binary descriptors. The keypoints 505, 510 may be matched or associated with each other if the value of the Hamming distance is less than a threshold, as discussed herein. For example, a pair of matching keypoints 505, 510 is indicated by the arrow 515. In some embodiments, vectors of integers representative of the keypoints 505, 510 or a measure of color similarity between the keypoints 505, 510 may be used to determine whether the keypoints 505, 510 match, as discussed herein.

The human 108 may be identified in the candidate region if a percentage of the matching keypoints 505, 510 exceeds a threshold. For example, twelve keypoints 505 are identified in the bounding box 308 and seven of these twelve are determined to match the seven keypoints 510 identified in the candidate region. Thus, just over half of the keypoints 505 are determined to match keypoints 510 in the candidate region, which may exceed a threshold such as a 50% match rate for the keypoints. Conversely, all of the seven keypoints 510 identified in the candidate region matched keypoints 505 identified in the bounding box 308, which is a 100% match rate. In some embodiments, a motion history may be generated for the human 108 in response to determining that the human 108 is identified in the bounding box 308 and the candidate region. The motion history may include the identified locations of the human 108, a direction of motion of the human 108, a speed of the human 108, and the like. The motion history may be determined using averages over a predetermined number of previous video images or other combinations of information generated from one or more previous video images. In some embodiments, a new bounding box may be defined for the occluded human 108.

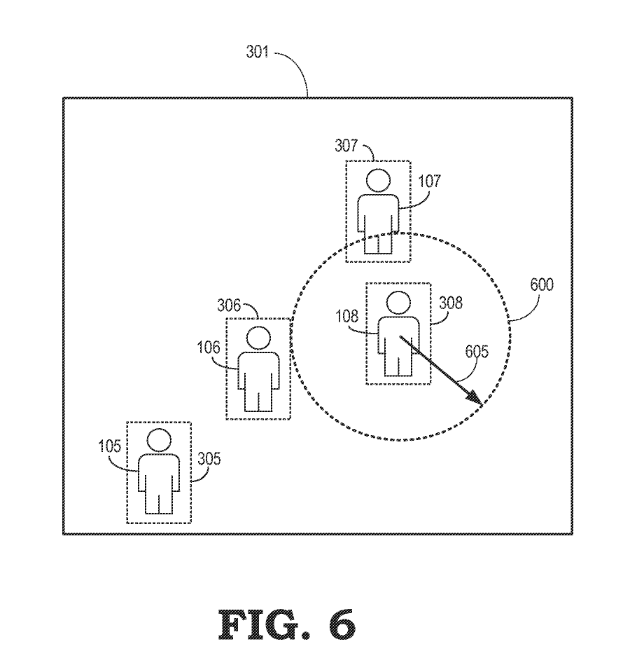

FIG. 6 is a diagram of a video frame 301 including a candidate region 600 around a human 108 according to some embodiments. The candidate region 600 is a circular region having a radius 605. As discussed herein, the radius 605 may be determined based on a speed of the human 108 indicated in the corresponding motion history or a maximum speed of the human 108. Keypoints may then be defined within the candidate region 600 and the keypoints may be compared to keypoints defined in other video images to identify fully or partially occluded images of the human 108, as discussed herein.

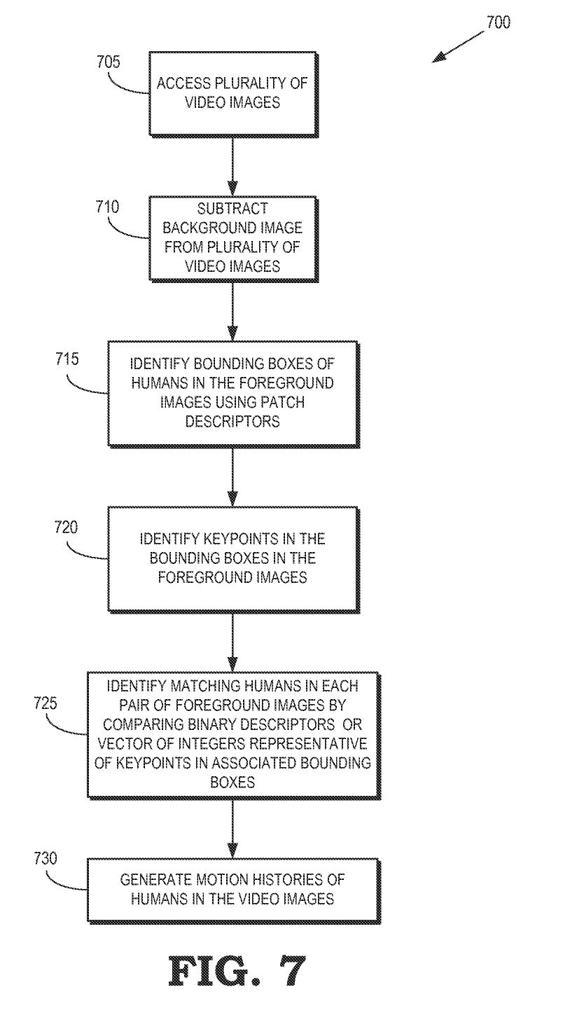

FIG. 7 is a flow diagram of a method 700 for identifying and tracking humans in a sequence of video images according to some embodiments. The method 700 may be implemented in one or more processors, servers, or other computing devices, as discussed herein. At block 705, a plurality of video images from the sequence of video images is accessed. For example, information indicating intensity or color values of pixels in the video images may be retrieved from a memory. At block 710, a background image is determined and subtracted from the plurality of video images to generate a plurality of foreground images. For example, as discussed herein, the background image may be determined by averaging the pixel values for a predetermined number of video images. At block 715, bounding boxes around images of humans are identified in the foreground images using a patch descriptor technique such as HOG. At block 720, keypoints are identified in the bounding boxes, e.g., by evaluating intensity values for pixels in a predetermined area around potential keypoints.

Matching humans are identified (at block 725) in pairs of foreground images by comparing binary descriptors or vectors of integers representative of the keypoints in bounding boxes in the pairs of foreground images. In some embodiments, matching humans may also be identified (at block 725) in pairs of foreground images by comparing binary descriptors or vectors of integers representative of keypoints in bounding boxes to binary descriptors or vectors of integers representative of keypoints in candidate regions that were not identified by the patch descriptor technique, as discussed herein. At block 730, motion history for the identified humans may be generated. For example, locations of the same human in different video images may be used to calculate a distance traversed by the human in the time interval between the video images, which may be used to determine a speed or velocity of the human. The motion history for the identified humans may then be stored, e.g., in a database or other data structure.

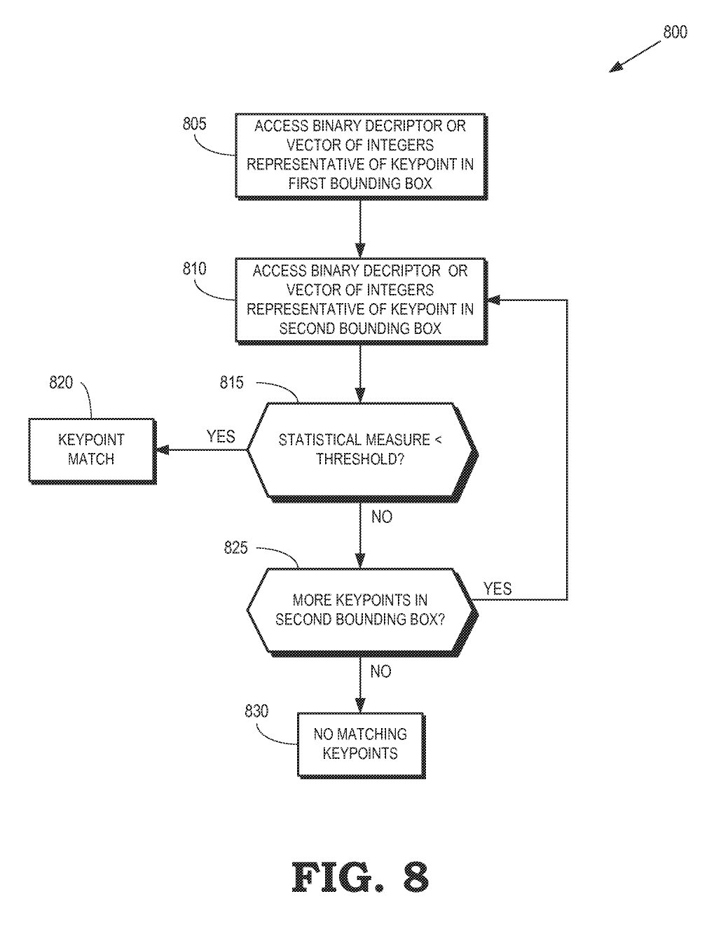

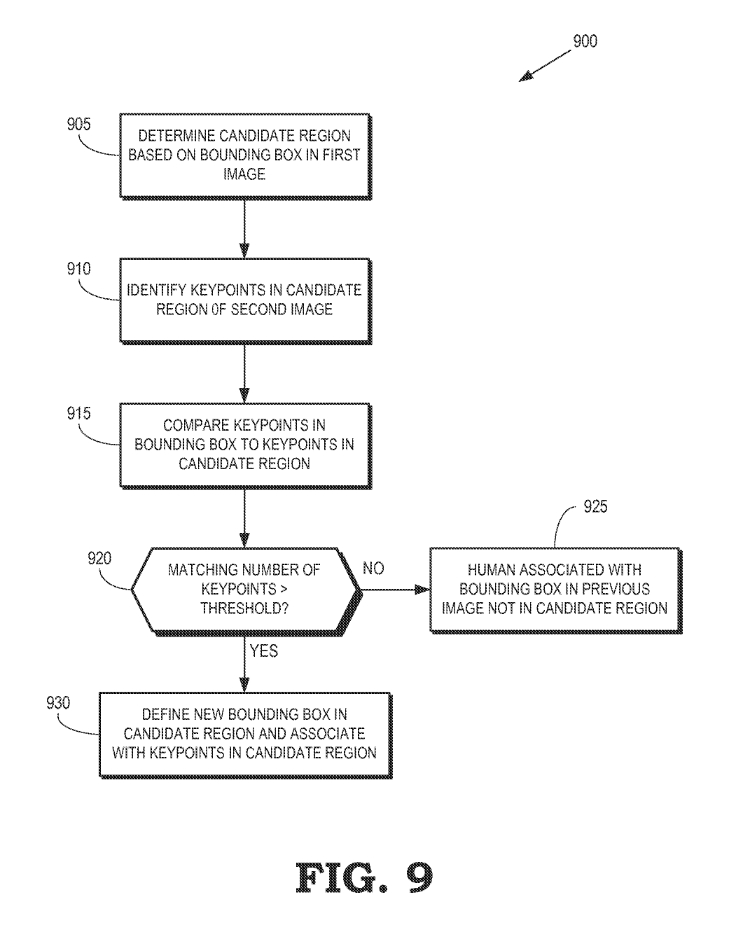

FIG. 8 is a flow diagram of a method 800 for comparing keypoints in bounding boxes in different video images according to some embodiments. The method 800 may be implemented in one or more processors, servers, or other computing devices, as discussed herein. At block 805, a binary descriptor or a vector of integers representative of a keypoint in a first bounding box in a first image is accessed, e.g., by reading the binary descriptor or vector of integers from a memory. At block 810, a binary descriptor or vector of integers representative of a keypoint in a second bounding box in a second image is accessed, e.g., by reading the binary descriptor or vector of integers from the memory. At decision block 815, a Hamming distance between the binary descriptors (or other statistical measure of the difference between the vectors of integers) is computed and the Hamming distance (or other statistical measure) is compared to a threshold value. If the Hamming distance (or other statistical measure) is less than the threshold value, indicating a high degree of similarity between the keypoints and a high probability that the keypoints match, the keypoints may be identified as a match at block 820. If the Hamming distance (or other statistical measure) is greater than the threshold value, indicating a low degree of similarity between the keypoints and a low probability that the keypoints match, the keypoints may be considered non-matching keypoints.

If more keypoints are available in the second bounding box (as determined at decision block 825), the binary descriptor or vector of integers representative of the additional keypoint may be accessed (at block 810) and compared to the binary descriptor or vector of integers representative of the keypoint in the first bounding box. If no more keypoints are available in the second bounding box (as determined at decision block 825), the method 800 may end by determining (at block 830) that there are no matching keypoints between the first bounding box and the second bounding box. Consequently, the method 800 determines that the images of humans associated with the first bounding box and the second bounding box are of different people.

FIG. 9 is a flow diagram of a method 900 for comparing keypoints in a bounding box in a first video image to keypoints in a candidate region of a second video image according to some embodiments. The method 900 may be implemented in one or more processors, servers, or other computing devices, as discussed herein. At block 905, a candidate region in the second video image is identified based on a bounding box identified in a first image using a patch descriptor technique. For example, the candidate region may correspond to an extension of the bounding box, a circular region surrounding the bounding box, or a region that is displaced from the bounding box by a distance or direction determined based on a motion history of the human in the bounding box, as discussed herein. At block 910, keypoints identified in the candidate region. At block 915, keypoints in the bounding box are compared to the keypoints identified in the candidate region, e.g., using portions of the method 800 shown in FIG. 8.

At decision block 920, the number of matching keypoints is compared to a threshold. The threshold may indicate an absolute number of matching keypoints or a percentage of the total number of keypoints in the bounding box or candidate region that match. If the matching number of keypoints is less than the threshold, the method 900 determines (at block 925) that the human associated with the bounding box in the first image is not present in the candidate region of the second image. If the matching number of keypoints is greater than the threshold, the method 900 determines that the human associated with the bounding box in the first image is present in the candidate region of the second image. At block 930, a new bounding box encompassing the candidate region is defined and associated with the image of the human identified by the keypoints in the candidate region. The new bounding box may be used to identify or track the associated human in other video images in a sequence of video images.

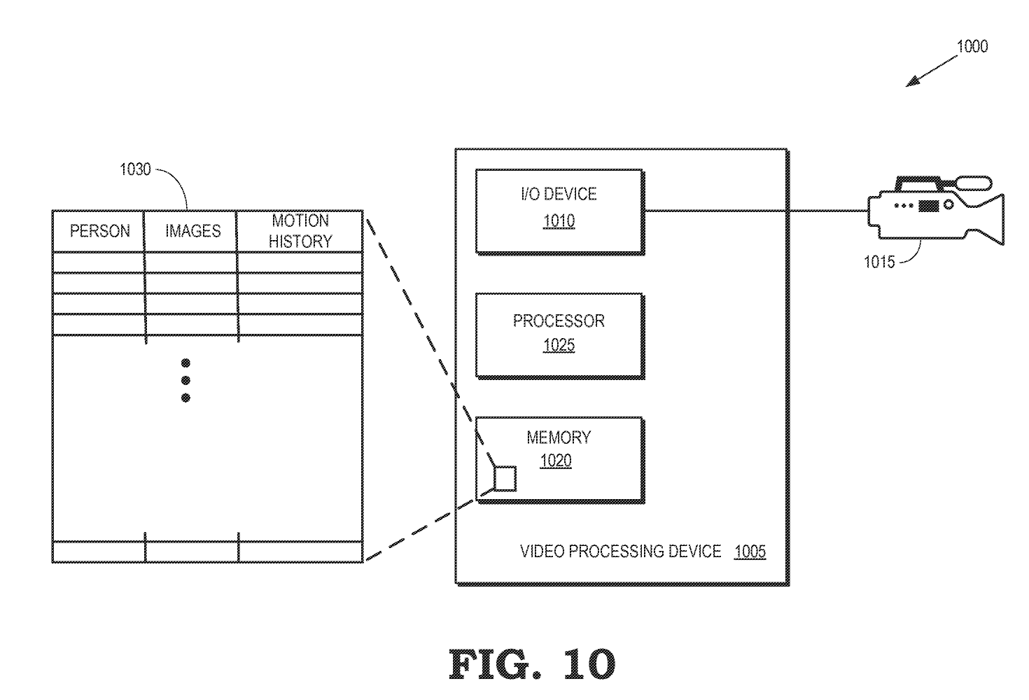

FIG. 10 is a block diagram of a video processing system 1000 according to some embodiments. The video processing system 1000 includes a video processing device 1005. Some embodiments of the video processing device 1005 include an input/output (I/O) device 1010 that receives sequences of video images captured by a camera 1015. The sequence of video images may be digital representations of the video images or analog images (e.g., frames of a film) that may be subsequently converted into a digital format. The I/O device 1010 may receive the sequence of video images directly from the camera 1015 or from a device that stores the information acquired by the camera 1015 such as a flash memory card, a compact disk, a digital video disc, a hard drive, a tape, and the like. The sequence of video images acquired by the I/O device 1010 may be stored in a memory 1020. Some embodiments of the memory 1020 may also include information that represents instructions corresponding to the method 700 shown in FIG. 7, the method 800 shown in FIG. 8, or the method 900 shown in FIG. 9.

The video processing device 1005 includes one or more processors 1025 that can identify or track images of humans in the video images captured by the camera 1015. Some embodiments of the processors 1025 may identify or track images of humans in the video images by executing instructions stored in the memory 1020. For example, the video processing device 1005 may include a plurality of processors 1025 that operate concurrently or in parallel to identify or track images of humans in the video images according to instructions for implementing the method 700 shown in FIG. 7, the method 800 shown in FIG. 8, or the method 900 shown in FIG. 9. The processors 1025 may store information associated with the identified humans in a data structure 1030 that may be stored in the memory 1020. Some embodiments of the data structure 1030 may include fields for storing information indicating the identified person and indicating the video images that include the identified person. The data structure 1030 may also include information indicating a motion history of the person such as the locations of the person in the video images, the speed of the person in the video images, the direction of motion of the person in the video images, and the like. Information in the data structure 1030 may therefore be used to count the people in the frames, track the people in the frames, or predict the future location of the people in the frames.

In some embodiments, certain aspects of the techniques described above may implemented by one or more processors of a processing system executing software. The software comprises one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

A non-transitory computer readable storage medium may include any storage medium, or combination of storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disc , magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. A method comprising:
accessing a first video image and a second video image from a sequence of video images;
applying a patch descriptor technique to determine a first portion of the first video image that encompasses a first person; and
determining a location of the first person in the second video image by comparing keypoints in the first portion of the first video image to at least one keypoint in the second video image.

2. The method of claim 1, further comprising:
determining a background video image based on a subset of the sequence of video images; and
generating first and second foreground video images by subtracting the background video image from the first and second video images.

3. The method of claim 2, wherein applying the patch descriptor technique comprises applying the patch descriptor technique to the first foreground video image to determine the first portion that encompasses the first person.

4. The method of claim 3, further comprising:
determining the keypoints in the first portion of the first video image and the at least one keypoint in the second video image using the first foreground video image and the second foreground video image, respectively.

5. The method of claim 1, wherein determining the location of the first person in the second video image comprises comparing keypoints in the first portion of the first video image to at least one keypoint in a second portion of the second video image determined using the patch descriptor technique and determining that the second portion encompasses the first person in response to a percentage of matching keypoints in the first portion and the second portion exceeding a threshold.

6. The method of claim 5, wherein determining the location of the first person in the second video image comprises determining that the first person is not visible in the second video image in response to a percentage of the keypoints in the first portion of the first video that matches the at least one keypoint in the second portion being below the threshold.

7. The method of claim 5, further comprising:
determining the second portion of the second video image based on at least one of the first portion of the first video image and a motion history associated with the first portion of the first video image.

8. The method of claim 1, further comprising:
generating a motion history for the first person in response to determining the location of the first person in the second video image.

9. The method of claim 1, further comprising:
identifying a third person in the second video image by comparing the keypoints in the first video image to at least one keypoint in a candidate region in the second video image, wherein the third person is not identified in the first video image by the patch descriptor technique.

10. An apparatus comprising:
a memory to store a first video image and a second video image from a sequence of video images; and
at least one processor to apply a patch descriptor technique to the first video image and the second video image to determine a first portion of the first video image that encompasses a first person and to determine a location of the first person in the second video image by comparing keypoints in the first portion of the first video image to at least one keypoint in the second video image.

11. The apparatus of claim 10, wherein the at least one processor is to determine a background image based on a subset of the sequence of video images and generate first and second foreground video images by subtracting the background image from the first and second video images.

12. The apparatus of claim 11, wherein the at least one processor is to apply the patch descriptor technique to the first foreground video image to determine the first portion that encompasses the first person.

13. The apparatus of claim 12, wherein the at least one processor is to determine the keypoints in the first portion of the first video image and the at least one keypoint in the second video image using the first foreground video image and the second foreground video image, respectively.

14. The apparatus of claim 10, wherein the at least one processor is to compare keypoints in the first portion of the first video image to at least one keypoint in a second portion of the second video image determined using the patch descriptor technique and determine that the second portion encompasses the first person in response to a percentage of matching keypoints in the first portion and the second portion exceeding a threshold.

15. The apparatus of claim 14, wherein the at least one processor is to determine that the first person is not visible in the second video image in response to a percentage of the keypoints in the first portion of the first video that matches the at least one keypoint in the second portion being below the threshold.

16. The apparatus of claim 14, wherein the at least one processor is to determine the second portion of the second video image based on at least one of the first portion of the first video image and a motion history associated with the first portion of the first video image.

17. The apparatus of claim 10, wherein the at least one processor is to generate a motion history for the first person in response to determining the location of the first person in the second video image.

18. The apparatus of claim 10, wherein the at least one processor is to identify a third person in the second video image by comparing the keypoints in the first video image to at least one keypoint in a candidate region in the second video image, wherein the third person is not identified in the first video image by the patch descriptor technique.

19. A non-transitory computer readable medium embodying a set of executable instructions, the set of executable instructions to manipulate at least one processor to:
access a first video image and a second video image from a sequence of video images;
apply a patch descriptor technique to determine a first portion of the first video image that encompasses a first person; and
determine a location of the first person in the second video image by comparing keypoints in the first portion of the first video image to at least one keypoint in the second video image.

20. The non-transitory computer readable medium of claim 19, wherein the set of executable instructions is to manipulate the at least one processor to compare keypoints in the first portion of the first video image to at least one keypoint in a second portion of the second video image determined using the patch descriptor technique and determine that the second portion encompasses the first person in response to a percentage of matching keypoints in the first portion and the second portion exceeding a threshold.
